(19) United States
(12) Patent Application Publication
(10) Pub. No.: US 2014/0203721 A1
(43) Pub. Date: Jul. 24, 2014

(54) ACTIVE DAMPING FOR DIMMABLE DRIVER FOR LIGHTING UNIT

(71) Applicants: Haibo Qiao, Shanghai (CN); Zhen Yuan Guan, Shanghai (CN); Chao Peng, Shanghai (CN); Jianghong Kong, Shanghai (CN); Tianyi Wei, Shanghai (CN); Jian Jiang, Shanghai (CN)

(72) Inventors: Haibo Qiao, Shanghai (CN); Zhen Yuan Guan, Shanghai (CN); Chao Peng, Shanghai (CN); Jianghong Kong, Shanghai (CN); Tianyi Wei, Shanghai (CN); Jian Jiang, Shanghai (CN)

(21) Appl. No.: 13/809,284

(22) PCT Filed: Aug. 10, 2010
(86) PCT No.: PCT/IB10/53613

§ 371 Date: Mar. 6, 2014

(30) Foreign Application Priority Data
Jul. 13, 2010 (CN) 20101022823.7.7

(51) Int. Cl. H05B 33/08

(52) U.S. Cl. CPC H05B 33/0815
USPC 315/201

(57) ABSTRACT

A circuit (236, 300, 400, 536) is provided for an apparatus (200, 500) configured to convert an AC signal to a DC signal for driving at least one light source (240, 540). The circuit includes a damping element (350, 450) configured to damp a current in the apparatus during time periods when the current exceeds a threshold, and a bypass path (340, 440) for bypassing the damping element during time periods when the current does not exceed the threshold.

### TECHNICAL FIELD

The present invention is directed generally to a lighting unit and a driver for a lighting unit. More particularly, various inventive methods and apparatus disclosed herein relate to an arrangement and method for providing damping of high current levels generated in a driver for a lighting unit.

### BACKGROUND

Illumination devices based on semiconductor light sources, such as light-emitting diodes (LEDs), offer a viable alternative to traditional fluorescent, HID, and incandescent lamps. Functional advantages and benefits of LEDs include high energy conversion and optical efficiency, durability, lower operating costs, and many others. Recent advances in LED technology have provided efficient and robust full-spectrum lighting units that enable a variety of lighting effects in many applications. Some lighting units feature one or more light sources, including one or more LEDs capable of producing different colors, e.g. red, green, and blue, as well as a processor for independently controlling the output of the LEDs in order to generate a variety of colors and color-changing lighting effects.

Many lighting applications make use of dimmers. Conventional dimmers work well with incandescent (bulb and halogen) lamps. However, problems occur with other types of electronic light sources such as compact fluorescent lamps (CR), low voltage halogen lamps using electronic transformers, and solid state lighting (SSL) lamps such as LEDs and OLEDs. Conventional dimmers typically chop a portion of each waveform of the input mains voltage signal and pass the remainder of the waveform to the lighting source. A leading edge or triode alternating current (triac) dimmer is a widely used type of dimmer that is of simple circuit design and low cost.

As LED s and other “next generation” light sources replace traditional fluorescent, HID, and incandescent lamps in various applications, there is a desire to provide many of the same features that the traditional light sources have provided, including in particular, a dimming capability.

Signals output by some dimming circuits can cause a large inrushing current or current spike which flows through the dimmer and a rectifier of the driver that drives the LEDs, possibly causing damage. Especially, when many lighting units and drivers are connected to one dimmer, the total inrush current can damage the dimmer. In an even more serious case, a wall breaker can be triggered by the huge current when many lighting units and drivers are connected to one breaker. One solution to this problem involves providing a damping resistor to damp the current in the driver and thereby prevent it from exceeding a desired threshold.

However, power consumed by the current flowing through the damping resistor is lost power that does not generate light and therefore reduces the operating efficiency of the lighting unit, especially during those times when the light source is not being dimmed and when the current spikes do not occur. Furthermore, this problem becomes worse as these “next generation” light sources, such as LED light sources, operate at greater power levels and therefore increased current levels.

Thus, there is a need in the art to provide a driver for a lighting source which can damp harmful high current levels while maintaining acceptable power efficiency.

### SUMMARY

The present disclosure is directed to a driver for a lighting unit. For example, the present disclosure describes a dimmable driver for a lighting unit, such as an LED lighting unit, which is provided with a damping element to damp a current in the driver during time periods when the current exceeds a threshold (e.g., as a result of current spikes generated in a dimming operation), and which also includes a bypass path for bypassing the damping element during the time periods when the current does not exceed the threshold.

Generally, in one aspect, an apparatus comprises: at least one light source; a rectifier for receiving a selectively modified sinusoidal signal, wherein a selectable leading portion or trailing portion of each cycle of a sinusoidal signal is substantially removed, and for outputting a rectified voltage; a DC/DC converter for adapting an output voltage of the rectifier for driving the at least one light source; and a damping circuit. The damping circuit comprises: a damping element for attenuating a current output by the rectifier to the DC converter in response to the selectively modified sinusoidal signal, a switch arranged in parallel with the damping element, a detector for detecting the current output by the rectifier, and a control unit for controlling the switch to be off when the detected current exceeds a threshold, and for controlling the switch to be on and to bypass the damping element when the detected current is less than the threshold.

In one embodiment, the detector is a resistor in series with a current output path of the rectifier.

In one embodiment, the control unit comprises a transistor whose bias is controlled by the current through the resistor, the transistor having an output that responds to the bias such that the transistor causes the switch to be off when the detected current exceeds a threshold, and for controlling the switch to be on and to bypass the damping element when the detected current is less than a threshold.

Generally, in another aspect, a circuit is provided for an apparatus configured to convert an AC signal to a DC signal for driving at least one light source. The circuit includes a damping element configured to damp a current in the apparatus during time periods when the current exceeds a threshold, and a bypass path for bypassing the damping element during time periods when the current does not exceed the threshold.

In one embodiment, the bypass path comprises a switch arranged in parallel with the damping element.

In one embodiment, the circuit further includes: detector for detecting the current; and a control circuit for controlling the switch to be off when the detected current exceeds the threshold, and for controlling the switch to be on and to bypass the damping element when the detected current is less than the threshold.

According to one optional feature of this embodiment, the detector includes a resistor.

According to another optional feature of this embodiment, the control circuit comprises a transistor whose bias is controlled by the current through the resistor, the transistor having an output that responds to the bias such that the transistor causes the switch to be off when the detected current exceeds the threshold, and for controlling the switch to be on and to bypass the damping element when the detected current is less than the threshold.

Generally, in still another aspect a method is provided for driving at least one light source. The method includes: determining whether a current in an apparatus configured to convert an AC signal to a DC signal for driving the at least one light source exceeds a threshold; when the current exceeds the threshold, damping the current with a damping element; and when the current does not exceed the threshold, bypassing the damping element so that the damping element does not damp the current.

In one embodiment, the method also includes: receiving a sinusoidal signal; in response to the AC supply voltage and the user input, selectively modifying the sinusoidal signal to substantially remove at least one of a leading portion or trailing portion of each cycle of the sinusoidal signal; and outputting a rectified voltage in response to the AC signal in response to the selectively modified sinusoidal signal.

According to one optional feature of this embodiment, the method also includes damping the current during a portion of each cycle of the selectively modified sinusoidal signal; and bypassing the damping element during a remainder of each cycle of the selectively modified sinusoidal signal.

According to another optional feature of this embodiment, the method also includes bypassing the damping element comprises connecting a switch in parallel across the damping element.

As used herein for purposes of the present disclosure, the term “LED” should be understood to include any electroluminescent diode or other type of carrier injection/junction-based system that is capable of generating radiation in response to an electric signal. Thus, the term LED includes, but is not limited to, various semiconductor-based structures that emit light in response to current, light emitting polymers, organic light emitting diodes (OLEDs), electroluminescent strips, and the like. In particular, the term LED refers to light emitting diodes of all types (including semi-conductor and organic light emitting diodes) that may be configured to generate radiation in one or more of the infrared spectrum, ultraviolet spectrum, and various portions of the visible spectrum (generally including radiation wavelengths from approximately 400 nanometers to approximately 700 nanometers). For example, one implementation of an LED configured to generate essentially white light (e.g., a white LED) may include a number of dies which respectively emit different spectra of electroluminescence that, in combination, mix to form essentially white light. In another implementation, a white light LED may be associated with a phosphor material that converts electroluminescence having a first spectrum to a different second spectrum. In one example of this implementation, electroluminescence having a relatively short wavelength and narrow bandwidth spectrum “pumps” the phosphor material, which in turn radiates longer wavelength radiation having a somewhat broader spectrum.

It should also be understood that the term LED does not limit the physical and/or electrical package type of an LED. For example, as discussed above, an LED may refer to a single light emitting device having multiple dies that are configured to respectively emit different spectra of radiation (e.g., that may or may not be individually controllable).

The term “light source” should be understood to refer to any one or more of a variety of radiation sources, including, but not limited to, LED-based sources (including one or more LEDs as defined above), incandescent sources (e.g., filament lamps, halogen lamps), fluorescent sources, phosphorescent sources, high-intensity discharge sources (e.g., sodium vapor, mercury vapor, and metal halide lamps), lasers, other types of electroluminescent sources, pyro-luminescent sources (e.g., flames), candle-luminescent sources (e.g., gas mantles, carbon arc radiation sources), photo-luminescent sources (e.g., gaseous discharge sources), cathode luminescent sources using electronic satiation, galvano-luminescent sources, crystallo-luminescent sources, kine-luminescent sources, thermo-luminescent sources, triboluminescent sources, sonoluminescent sources, radioluminescent sources, and luminescent polymers.

A given light source may be configured to generate electromagnetic radiation within the visible spectrum, outside the visible spectrum, or a combination of both. Hence, the terms “light” and “radiation” are used interchangeably herein. Additionally, a light source may include as an integral component one or more filters (e.g., color filters), lenses, or other optical components. Also, it should be understood that light sources may be configured for a variety of applications, including, but not limited to, indication, display, and/or illumination. An “illumination source” is a light source that is particularly configured to generate radiation having a sufficient intensity to effectively illuminate an interior or exterior space. In this context, “sufficient intensity” refers to sufficient radiant power in the visible spectrum generated in the space or environment (the unit “lumens” often is employed to represent the total light output from a light source in all directions, in terms of radiant power or “luminous flux”) to provide ambient illumination (i.e., light that may be perceived indirectly and that may be, for example, reflected off of one or more of a variety of intervening surfaces before being perceived in whole or in part).

The term “lighting unit” is used herein to refer to an apparatus including one or more light sources of same or different types. A given lighting unit may have any one of a variety of mounting arrangements for the light source(s), enclosure/housing arrangements and shapes, and/or electrical and mechanical connection configurations. Additionally, a given lighting unit optionally may be associated with (e.g., include, be coupled to and/or packaged together with) various other components (e.g., control circuitry) relating to the operation of the light source(s). An “LED-based lighting unit” refers to a lighting unit that includes one or more LED-based light sources as discussed above, alone or in combination with other non LED-based light sources.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention.

FIGS. 1A-B show signals pertaining to operation of a leading edge light dimmer.

FIG. 2 shows a functional block diagram of one embodiment of a lighting unit having a driver.

FIG. 3 shows a block diagram of one embodiment of an active damping circuit for a driver of a lighting unit.

FIG. 4 shows a schematic diagram of one embodiment of a damping circuit for a driver of a lighting unit.

FIG. 5 shows a schematic diagram of one embodiment of a lighting unit.

### DETAILED DESCRIPTION

Applicants have recognized and appreciated that it would be beneficial to provide a driver for a light source, such as an LED light source, that can damp a large current that can be produced from a dimming circuit, while permitting higher operating efficiencies than if a simple damping resistor was always present in the current path. In view of the foregoing, various embodiments and implementations of the present invention are directed to a driver of a lighting unit, such as an LED-based lighting unit, which is provided with a damping element to damp a current in the driver during time periods when the current exceeds a threshold (e.g., as a result of current spikes generated in a dimming operation), and which also includes a bypass path for bypassing the damping element during the time periods when the current does not exceed the threshold.

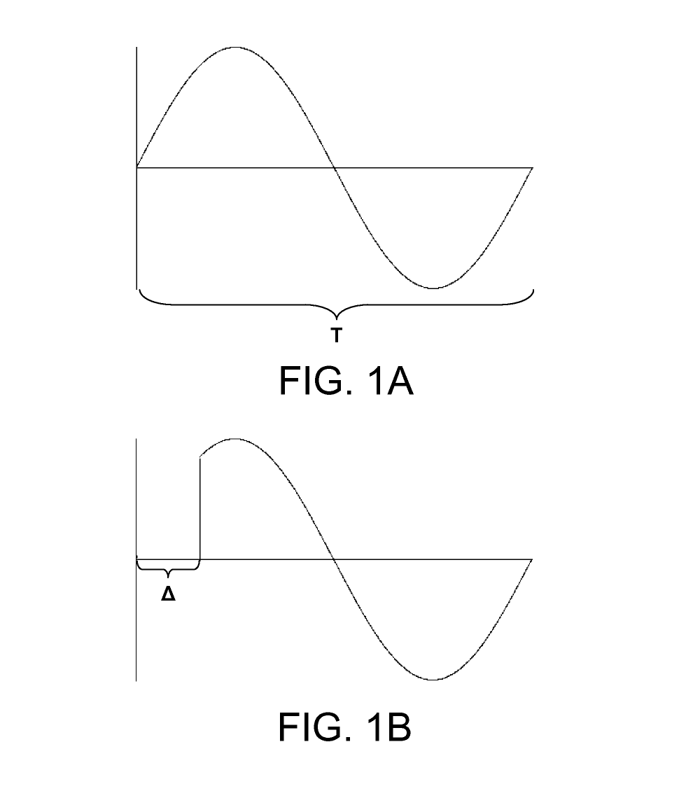

FIGS. 1A and 1B illustrate operation of a leading edge light dimmer (also sometimes referred to as a light dimming circuit) for a light source. FIG. 1A shows a sinusoidal signal (e.g., 60 Hz) that may be provided from standard power lines connected to a power grid. To dim a light source that is powered from these power lines, a leading edge light dimmer may be interposed between the power lines and the light source. FIG. 1B shows the output signal provided by the leading edge light dimmer. In response to a user control (e.g., a rotatable knob or a slide control), the leading edge light dimmer selectively modifies the sinusoidal signal to substantially remove a selectable leading portion or segment Δ of each cycle or period T of the sinusoid such that the voltage is substantially zero during the segment Δ. As the user control is adjusted to dim the light, the segment Δ where the voltage is substantially zero is made longer. Conversely, as the user control is adjusted to make the light brighter, the segment Δ where the voltage is substantially zero is made shorter. For example when no dimming is desired, the segment Δ may be eliminated. In addition to leading edge light dimmer, trailing edge light dimmers are also known which selectively modify the sinusoidal signal to substantially remove a selectable trailing portion or segment of each cycle or period of the sinusoid.

Meanwhile, solid state lighting units (e.g., LED-based lighting units) typically include a driver for supplying a proper voltage and current to the light source(s).

When the modified sine wave of FIG. 1B is applied to such a driver, a large inrushing current occurs at the end of the segment Δ where the voltage steps up quickly from zero (or nearly zero) to the “normal” sine wave voltage due to a capacitor at the output of a rectifier circuit in the driver. To prevent a current overload from damaging the operation of the driver which is to be employed in a leading-edge dimming mode, a damping circuit may be included in the driver. In one example, a substantial resistor (e.g., 200 ohms) may be placed in series at the input circuit to govern the peak current that is applied to the driver in such a case.

However, as solid state (e.g., LED-based) lighting units operate at greater power levels this passive current damping approach produces undesirable consequences. For example, in a high power LED-based lighting unit whose power is greater than 20 W, the root-mean-squared (RMS) input current can be 0.2 amperes, and therefore the damping resistor as described above will cause a power loss of (0.2 A)²*200 ohm=8 W. 8 Watts of lost power in a 20 Watt lighting unit is undesirably high.

So there is a need to provide a solution which can to reduce this power loss while still providing protection for large peak currents, for example inrushing currents that may occur when operating with a leading edge light dimmer.

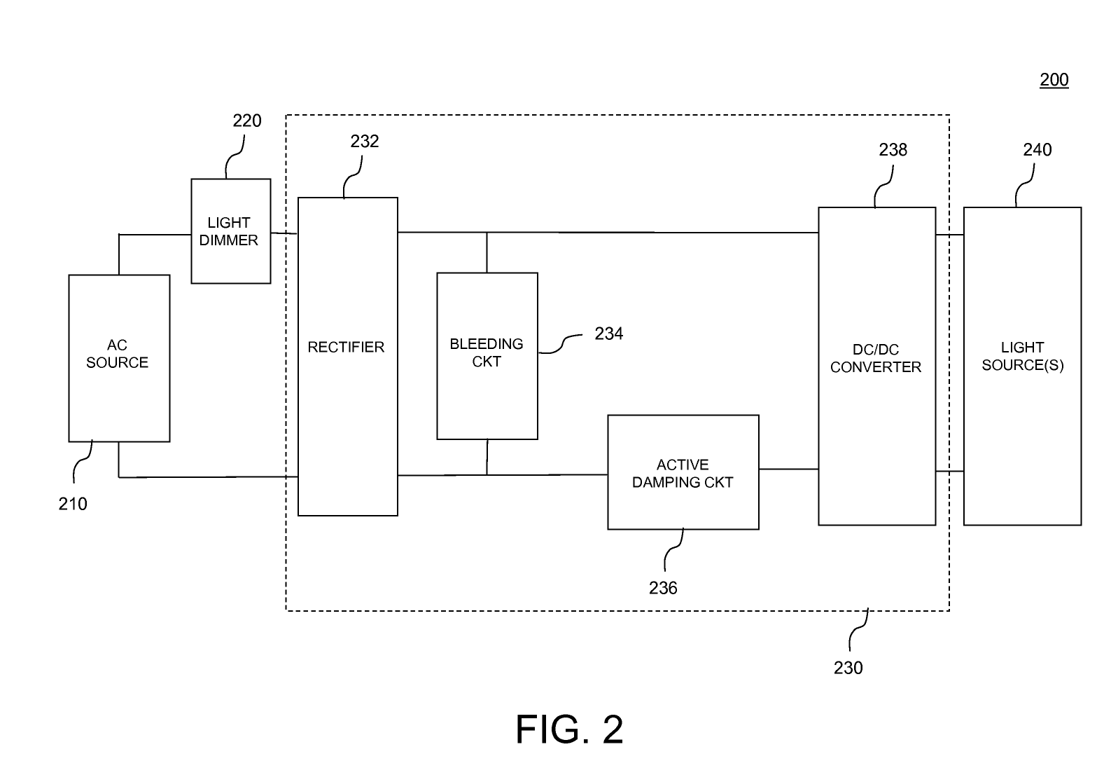

FIG. 2 shows a functional block diagram of one embodiment of a lighting unit 200 having a driver 230. Lighting unit 200 receives AC power from an AC source 210, and includes a light dimmer 220 and one or more light sources (e.g., LED-based light sources) 240. Driver 230 includes a rectifier (e.g., a rectifier bridge) 232, a bleeding circuit 234, a damping circuit (e.g., an active damping circuit) 236, and a DC/DC converter 238. In some embodiments, light dimmer 220 may be a leading edge light dimmer, or a trailing edge light dimmer. Some embodiments may omit light dimmer 220.

In operation, driver 230 converts an AC signal received from AC source 210 (e.g., via light dimmer 220) to a DC signal for driving the one or more light sources 240.

Beneficially, as described in greater detail below, damping circuit 236 provides a damping function that is adapted to respond to the input current such that at times when the input current is greater than a set threshold, then the damping function is enabled to damp the large input current, bur when the input current is less than the set threshold, then the damping function is disabled and the power loss caused by damping is reduced or eliminated.

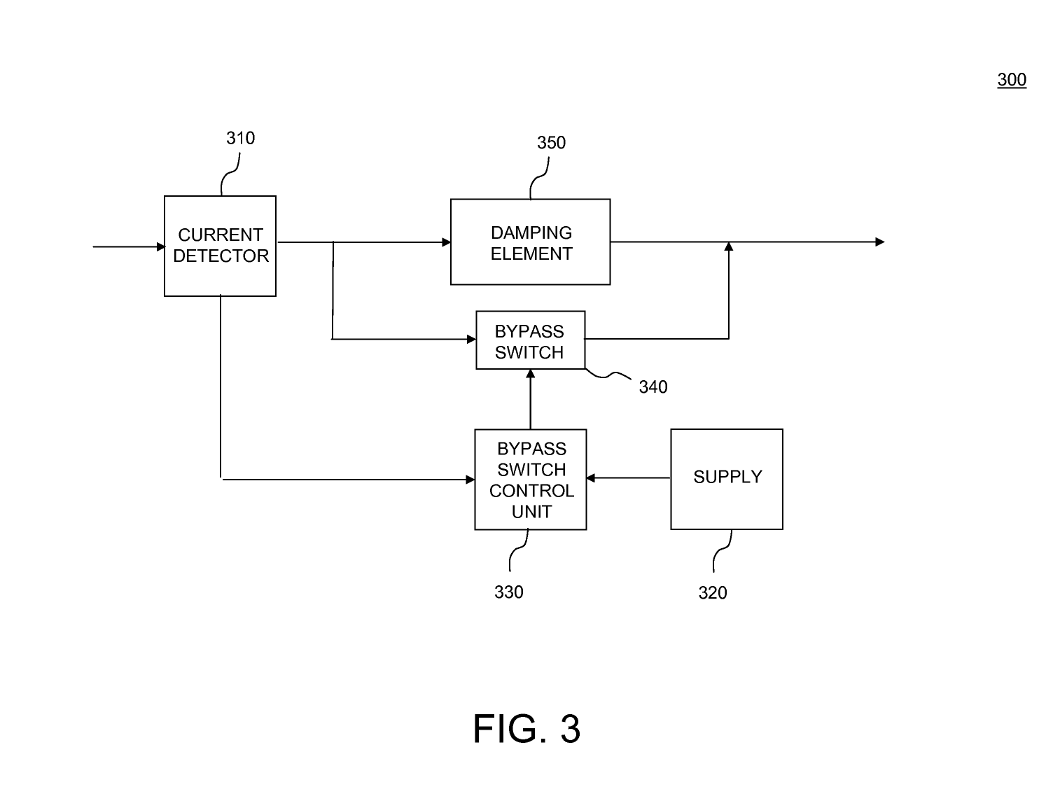

FIG. 3 shows a block diagram of one embodiment of a damping circuit 300 for a driver of a lighting unit (e.g., an embodiment of damping circuit 236 of driver 230 of lighting unit 200). Damping circuit 300 includes a detector (e.g., a current detector) 310, a power supply or source 320, a control unit 330, a switch 340 and a damping element 350.

In operation, detector 310 detects a current in the driver (e.g., driver 230 of lighting unit 200) that includes damping circuit 300. In response to the detected current, control unit 330—which is powered by power supply or source 320—controls switch 340 to be either opened or closed. When the input current is not large (i.e., less than a threshold set by control unit 330 in conjunction with detector 310) then detector 310 causes control unit 330 to close switch 340, which is arranged in parallel with damping element 350, thereby providing a bypass path for the input current to bypass damping element 350. As a result, damping element 350 does not cause a large power loss during times when the input current is not large—for example when there is no dimming of the light source and a normal sine wave is applied to the driver. However at times when the input current is greater than a threshold set by control unit 330 in conjunction with detector 310, such as in the case of a large inrushing current caused by a capacitor in DC/DC converter 238 of FIG. 2 when operating in a light dimming mode, then detector 310 causes control unit 330 to open switch 340, as a result of which the input current flows through damping element 350 to damp the large input current.

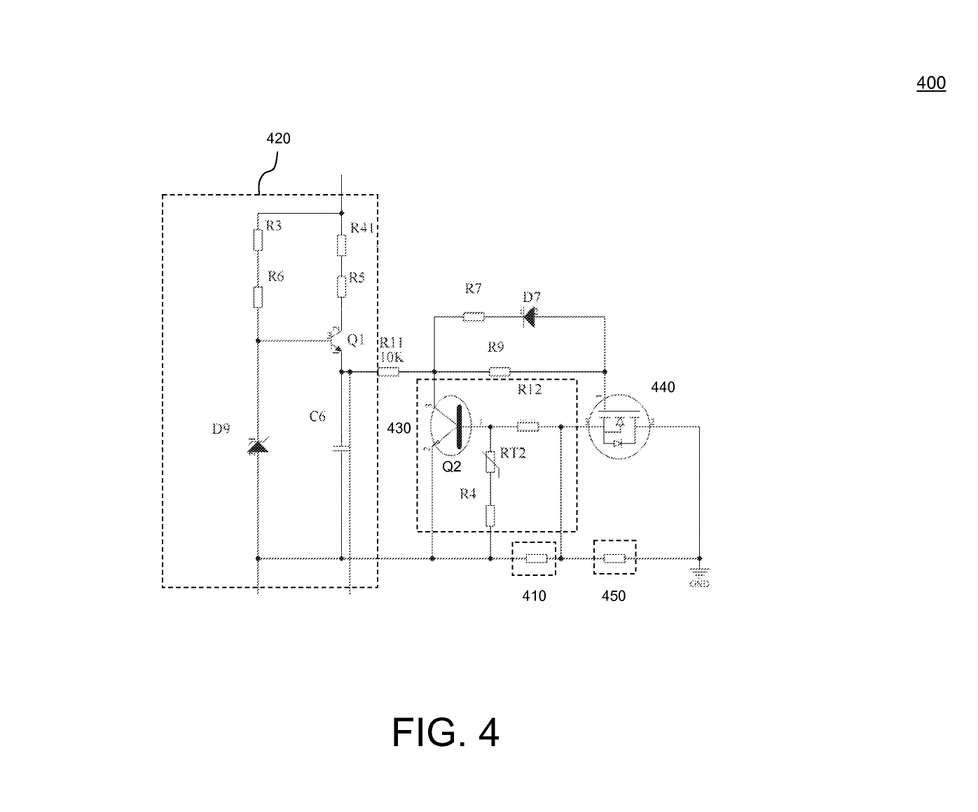

FIG. 4 shows a schematic diagram of one embodiment of a damping circuit 400 for a driver of a lighting unit (e.g., an embodiment of driver 230 of lighting unit 200). Damping circuit 400 includes a detector (e.g., a current detector) 410, a power supply or source 420, a control unit 430, a switch 440 and a damping element 450.

In damping circuit 400, detector 410 is a resistor, control unit 430 comprises a transistor Q2, switch 440 is a metal oxide semiconductor field effect transistor (MOSFET), and damping element 450 is a resistor. Power supply 420 includes R3, R5, R6, R41, D9, C6 and Q1, and provides the energy which can be used to turn on and off switch 440. In damping circuit 400, the input current flows through detector 410, thereby developing a voltage across the base-emitter junction of transistor Q2 in control circuit 430. That is, the bias of transistor Q2 is controlled by the current through detector (e.g., resistor) 410. As the input current increases, at some value a sufficient voltage is developed across detector 410 to turn on transistor Q2 and thereby cause control unit 430 to turn off switch 440 so that all of the input current will just go through damping element 450. So by properly selecting the value of resistance in detector 410 in conjunction with control circuit 430, a desired threshold can be set for the input current for turning on and off switch 440.

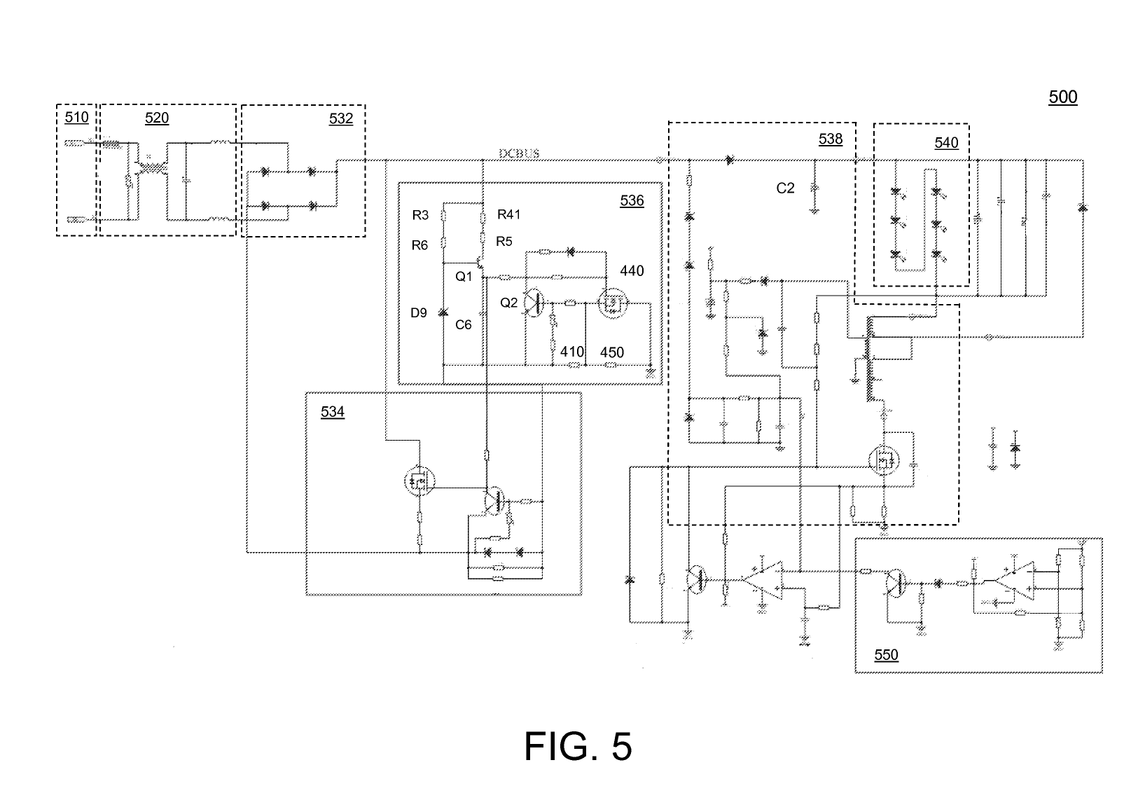

In operation, when there is no large inrushing input current, Q2 remains off and switch 440 remains “on” so as to bypass damping element 450. However when a large peak input current occurs, such as in the case of a large inrushing current caused by a capacitor C2 (see FIG. 5) in DC/DC converter 238 of FIG. 2 when operating in a light dimming mode, then the voltage across detector 410 increases so as to turn off Q2, which turns off switch 440 so that the input current must pass through damping element 450 to thereby damp the input current. In particular, when there is no light dimming operation, the large input current is generally avoided and damping element 450 remains bypassed. When the light dimming operation is invoked and a selectively modified sinusoidal signal (see FIG. 1B) is applied to a driver including damping circuit 400, then the current is damped by damping element 450 during a portion of each cycle or period of the selectively modified sinusoidal signal where the current sharply increases (e.g., around the end of segment Δ), and damping element 450 is bypassed by switch 440 during a remainder of each cycle or period of the selectively modified sinusoidal signal when the current is not so large.

This reduces the power loss caused by damping circuit 400, thereby increasing the efficiency of a driver and lighting unit that includes damping circuit 400, compared to a similar device that employs a passive damping circuit with just a resistor.

FIG. 5 shows a schematic diagram of one embodiment of a lighting unit 500, for example an embodiment of the lighting unit 200 of FIG. 2. Lighting unit 500 receives AC power from an AC source 510, and includes a light dimmer 520, a driver, one or more light sources (e.g., LED-based light sources) 540, and an over temperature protection circuit 550. The driver for lighting unit 500 includes a rectifier (e.g., a rectifier bridge) 532, a bleeding circuit 534, a damping circuit 536, and a DC/DC converter 538. Some embodiments may omit light dimmer 520.

In lighting unit 500, the driver is the same as driver 400 of FIG. 4. Notably, damping element 450 (e.g., a resistor) is in series with a current output path of rectifier 532 and can damp a large peak or transient current in the driver to prevent component damage. The operation of lighting unit 500 is similar to that of lighting unit 200 described above, and so a detailed description thereof will be omitted.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms. The indefinite articles “a” and “an,” as used herein in the specification and in the claims, unless clearly indicated to the contrary, should be understood to mean “at least one.” It should also be understood that, unless clearly indicated to the contrary, in any methods claimed herein that include more than one step or act, the order of the steps or acts of the method is not necessarily limited to the order in which the steps or acts of the method are recited.

Any reference numerals or other characters, appearing between parentheses in the claims, are provided merely for convenience and are not intended to limit the claims in any way.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

1. An apparatus, comprising:
at least one light source;
a rectifier for receiving a selectively modified sinusoidal signal, wherein a selectable leading portion or trailing portion of each cycle of a sinusoidal signal is substantially removed, and for outputting a rectified voltage;
a DC/DC converter for adapting an output voltage of the rectifier for driving the at least one light source; and
a damping circuit, comprising,
a damping element for attenuating a current output by the rectifier to the DC converter in response to the selectively modified sinusoidal signal,
a switch arranged in parallel with the damping element,
a detector for detecting the current output by the rectifier, and
a control unit for controlling the switch to be off when the detected current exceeds a threshold, and for controlling the switch to be on and to bypass the damping element when the detected current is less than the threshold.

2. The apparatus of claim 1, wherein the damping element comprises a resistor.

3. The apparatus of claim 1, wherein the switch comprises a MOSFET.

4. The apparatus of claim 1, wherein the detector is a resistor in series with a current output path of the rectifier.

5. The apparatus of claim 4, wherein the control unit comprises a transistor (Q2) whose bias is controlled by the current through the resistor, the transistor having an output that responds to the bias such that the transistor causes the switch to be off when the detected current exceeds a threshold, and for controlling the switch to be on and to bypass the damping element when the detected current is less than a threshold.

6. The apparatus of claim 1, wherein the at least one light source comprises one or more light emitting diodes.

7. The apparatus of claim 1, further comprising a light dimmer provided between an AC source and the rectifier.

8. A circuit for an apparatus configured to convert an AC signal to a DC signal for driving at least one light source, the circuit including a damping element configured to damp a current in the apparatus during time periods when the current exceeds a threshold, and a bypass path for bypassing the damping element during time periods when the current does not exceed the threshold.

9. The circuit of claim 8, wherein the damping element comprises a resistor.

10. The circuit of claim 8, wherein the bypass path comprises a switch arranged in parallel with the damping element.

11. The circuit of claim 10, wherein the switch comprises a MOSFET.

12. The circuit of claim 9, further comprising:
a detector for detecting the current; and
a control unit for controlling the switch to be off when the detected current exceeds the threshold, and for controlling the switch to be on and to bypass the damping element when the detected current is less than the threshold.

13. The circuit of claim 12, wherein the detector comprises a resistor.

14. The circuit of claim 13, wherein the control unit ti comprises a transistor (Q2) whose bias is controlled by the current through the resistor, the transistor having an output that responds to the bias such that the transistor causes the switch to be off when the detected current exceeds the threshold, and for controlling the switch to be on and to bypass the damping element when the detected current is less than the threshold.

15. A method of driving at least one light source, the method including:
determining whether a current in an apparatus configured to convert an AC signal to a DC signal for driving the at least one light source exceeds a threshold;
when the current exceeds the threshold, damping the current with a damping element; and
when the current does not exceed the threshold, bypassing the damping element so that the damping element does not damp the current.

16. The method of claim 15, further comprising dimming a light emitted by the lighting device in response to a user input.

17. The method of claim 16, further comprising:
receiving a sinusoidal signal;
in response to the AC supply voltage and the user input, selectively modifying the sinusoidal signal to substantially remove at least one of a leading portion or trailing portion of each cycle of the sinusoidal signal; and
outputting a rectified voltage in response to the AC signal in response to the selectively modified sinusoidal signal.

18. The method of claim 17, further comprising:
damping the current during a portion of each cycle of the selectively modified sinusoidal signal; and
bypassing the damping element during a remainder of each cycle of the selectively modified sinusoidal signal.

19. The method of claim 15, wherein determining whether the current exceeds the threshold comprises sampling the current with a resistor.

20. The method of claim 15, wherein bypassing the damping element comprises connecting a switch in parallel across the damping element.
